(19) United States
(12) Patent Application Publication
(10) Pub. No.: US 2024/0376296 A1
(43) Pub. Date: Nov. 14, 2024

(54) CELLULOSE-BASED RESIN COMPOSITION AND MOLDED BODY USING SAME

(71) Applicants: NEC Corporation, Minato-ku, Tokyo (JP); NEC Platforms, Ltd., Kawasaki-shi, Kanagawa (JP)

(72) Inventors: Yuto SANO, Tokyo (JP); Kiyohiko TOYAMA, Tokyo (JP); Shukichi TANAKA, Tokyo (JP); Midori SHIMURA, Tokyo (JP); Takuma OZAWA, Kanagawa (JP)

(73) Assignees: NEC Corporation, Minato-ku, Tokyo (JP); NEC Platforms, Ltd., Kawasaki-shi, Kanagawa (JP)

(21) Appl. No.: 18/291,953

(22) PCT Filed: Jul. 29, 2022
(86) PCT No.: PCT/JP2022/029266

§ 371 Date: Jan. 25, 2024

(30) Foreign Application Priority Data
Jul. 29, 2021 (JP) 2021-124850

(51) Int. Cl. C08L 1/12; C08K 3/22; C08K 5/521

(52) U.S. Cl. CPC C08L 1/12; C08K 3/22; C08K 5/521; C08K 2003/2227; C08L 2201/02

(57) ABSTRACT

Provided is a cellulose-based resin composition capable of forming a molded body excellent in flame retardancy and mechanical strength, and a molded body formed using the same. The present invention relates to a cellulose-based resin composition including: component (A): cellulose acetate, component (B): a predetermined phosphoric acid ester, component (C): an anti-dripping agent, and component (D): a metal hydroxide, wherein a content of the component (B) is 20% by mass or more and less than 30% by mass based on 100% by mass of a total content of the component (A) and the component (B), and a content of the component (D) is 10% by mass or more and 20% by mass or less based on 100% by mass of a total content of the components (A) to (D).

### TECHNICAL FIELD

The present invention relates to a cellulose-based resin composition and a molded body using the same.

### BACKGROUND ART

Since bioplastics made from plant components as raw materials can contribute to measures against petroleum depletion or measures against global warming, their use in general products such as packages, containers, and fibers as well as durable products such as electronics and automobiles has also been started.

General bioplastics, such as polylactic acid, polyhydroxyalkanate, and modified starch, are all made from starch-based materials, that is, edible parts. Accordingly, for fear of future food shortage, it had been desired to develop a novel bioplastic using a non-edible part as a raw material.

Such a non-edible part is typified by cellulose, which is a major component of wood or vegetation, and various bioplastics obtained using this have been developed and commercialized.

Since these plant-derived resins are generally flammable, flame retardant measures are necessary when they are used in applications that require a high degree of flame retardancy, such as a home appliance and a housing for office automation equipment. In particular, when a resin composition comprising a plant-derived resin is used for a housing of an electrical product, it is necessary to satisfy a flame retardant standard such as UL94 standard.

Resin compositions comprising flame retardants had been studied for the purpose of improving flame retardancy. For example, Patent document 1 discloses a resin composition comprising a polylactic acid resin, a cellulose ester, an aromatic polycarbonate resin, a compatibilizer and a flame retardant. Patent document 2 discloses a resin composition comprising a cellulose ester and a cyclic phosphorus compound having a specific structure. Patent document 3 discloses a flame-retardant thermoplastic resin composition comprising a polylactic acid resin, a flame retardant comprising a metal hydrate, and a high-strength fiber. Patent document 4 discloses a cellulose-based resin composition comprising a cellulose ester-based resin and a phosphoric acid ester having a specific structure.

### CITATION LIST

### Patent Literature

Patent Document 1: Japanese Patent Laid-Open Publication No. 2006-111858
Patent Document 2: Japanese Patent Laid-Open Publication No. 2011-241236
Patent Document 3: Japanese Patent Laid-Open Publication No. 2011-168798
Patent Document 4: WO2014/002720

### SUMMARY OF INVENTION

### Technical Problem

However, in Patent Documents 1 to 4, studies on cellulose-based resin compositions capable of forming molded bodies excellent in both of flame retardance and mechanical strength had been insufficient.

An object of the present invention is to provide a cellulose-based resin composition capable of forming a molded body excellent in flame retardancy and mechanical strength, and a molded body formed using the same.

### Solution to Problem

One aspect of the present embodiment relates to the following matters.

A cellulose-based resin composition comprising:
component (A): cellulose acetate,
component (B): one or more phosphoric acid esters selected from the group consisting of triphenyl phosphate, triethyl phosphate, tributyl phosphate, tricresyl phosphate, cresyl di-2,6-xylenyl phosphate, and a compound represented by the following formula (I):

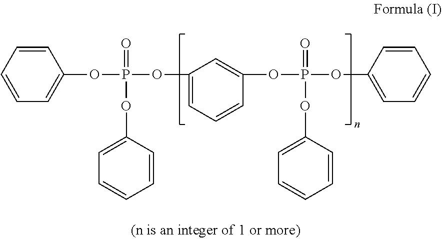

component (C): an anti-dripping agent, and
component (D): a metal hydroxide,
wherein a content of the component (B) is 20% by mass or more and less than 30% by mass based on 100% by mass of a total content of the component (A) and the component (B), and
a content of the component (D) is 10% by mass or more and 20% by mass or less based on 100% by mass of a total content of the components (A) to (D).

### Advantageous Effect of Invention

According to the present embodiment, it is possible to provide a cellulose-based resin composition capable of forming a molded body excellent in flame retardancy and mechanical strength, and a molded body formed using the same.

### DESCRIPTION OF EMBODIMENTS

A cellulose-based resin composition of the present embodiment (also simply referred to as “resin composition” or “cellulose acetate resin composition”) comprises:
component (A): cellulose acetate,
component (B): one or more phosphoric acid esters selected from the group consisting of triphenyl phosphate, triethyl phosphate, tributyl phosphate, tricresyl phosphate, cresyl di-2,6-xylenyl phosphate, and a compound represented by the following formula (I):

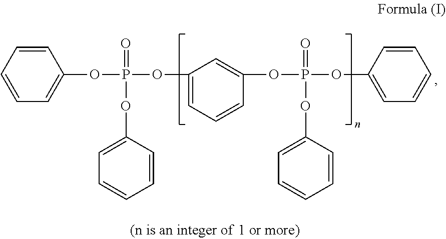

component (C): an anti-dripping agent, and
component (D): a metal hydroxide,
wherein a content of the component (B) is 20% by mass or more and less than 30% by mass based on 100% by mass of a total content of the component (A) and the component (B), and
a content of the component (D) is 10% by mass or more and 20% by mass or less based on 100% by mass of a total content of the components (A) to (D).

The present inventors have found that when a resin composition comprises cellulose acetate, the predetermined phosphoric acid ester, an anti-dripping agent and a metal hydroxide and the contents of the phosphoric acid ester and the metal hydroxide are each within the predetermined range, the resin composition excellent in both flame retardancy and mechanical strength can be obtained.

### <Component (A)>

The cellulose-based resin composition of the present embodiment comprises cellulose acetate (also described as “CA”) as component (A). Cellulose acetate in which an acetyl group is introduced into at least a part of hydroxy groups of cellulose as a raw material may be used.

Cellulose is a straight-chain polymer obtained by polymerizing β-D-glucose molecules (β-D-glucopyranose) represented by the following formula (1) via a β (1→4) glycoside bond. Each of glucose units constituting cellulose has three hydroxy groups (in the formula, n represents a natural number). In the present embodiment, an acetyl group is introduced into such cellulose by using these hydroxy groups.

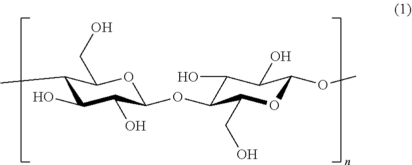

Cellulose is a main component of a plant and can be obtained by a separation treatment for removing other components such as lignin from a plant. Other than those thus obtained, cotton (for example, cotton linters) having a high cellulose content and pulp (for example, wood pulp) may be used directly or after they are purified. As the shape, size and form of the cellulose or a derivative thereof to be used as a raw material, a powder form cellulose or a derivative thereof having an appropriate particle size and particle shape is preferably used in view of reactivity, solid-liquid separation and handling. For example, a fibrous or powdery cellulose or a derivative thereof having a diameter of 1 to 100 μm (preferably 10 to 50 μm) and a length of 10 μm to 100 mm (preferably 100 μm to 10 mm) may be used, but is not limited thereto.

The polymerization degree of the cellulose in terms of polymerization degree (average polymerization degree) of glucose preferably falls within the range of 50 to 5000, more preferably 100 to 3000 and further preferably 100 to 1000. If the polymerization degree is extremely low, the strength and heat resistance of the produced resin may not be sufficient in some cases. Conversely, if the polymerization degree is extremely high, the melt viscosity of the produced resin becomes extremely high, interfering with molding in some cases.

The cellulose acetate used in the present embodiment can be obtained by introducing an acetyl group by use of hydroxy groups of a cellulose.

The above acetyl group can be introduced by reacting a hydroxy group of a cellulose and an acylating agent. The acetyl group corresponds to an organic group portion introduced in place of a hydrogen atom of a hydroxy group of the cellulose. The acylating agent is a compound having at least one functional group reactive to a hydroxy group of a cellulose; examples thereof include compounds having a carboxyl group, a carboxylic halide group or a carboxylic anhydride group. Specific examples of the compound include aliphatic monocarboxylic acid (acetic acid), an acid halide and acid anhydride thereof (acetic anhydride).

The average number of acetyl groups to be introduced per glucose unit of a cellulose (DS_{AC}) (an acetyl group introduction ratio); in other words, the average number of hydroxyl groups substituted with acetyl groups per glucose unit (degree of substitution of a hydroxyl group) may be set to fall within the range of 0.1 to 3.0. In order to obtain an introduction effect of an acetyl group sufficiently, particularly, in view of e.g., water resistance and flowability, DS_{AC} is preferably 2.0 or more, more preferably 2.2 or more and further preferably 2.4 or more. From the viewpoint of obtaining the effect of other groups (e.g., hydroxy group) while obtaining the introduction effect of an acetyl group sufficiently, DS_{AC} is preferably 2.9 or less and more preferably 2.8 or less.

By introducing an acetyl group into a cellulose as described above, it is possible to reduce intermolecular force (intramolecular bond) of the cellulose and to improve plasticity of the cellulose acetate resin composition.

As the residual amount of hydroxy groups increases, the maximum strength and heat-resistance of the cellulose acetate resin composition tend to increase; whereas water absorbability tends to increase. In contrast, as the conversion ratio (degree of substitution) of hydroxy groups increases, water absorbability tends to decrease, plasticity and breaking strain tend to increase; whereas, maximum strength and heat resistance tend to decrease. In consideration of these tendencies etc., the conversion ratio of hydroxy groups can be appropriately set.

The average number of the remaining hydroxy groups per glucose unit of the cellulose acetate (hydroxy group remaining degree) may be set to fall within the range of 0 to 2.9. In view of maximum strength, heat-resistance and the like, hydroxy groups may remain. For example, the hydroxy group remaining degree may be 0.01 or more and further 0.1 or more. Particularly, in view of flowability, the hydroxy group remaining degree of a final cellulose acetate is preferably 1.0 or less, more preferably 0.8 or less and further preferably 0.6 or less.

The molecular weight of cellulose acetate, as a weight average molecular weight, is preferably in the range of 10,000 to 400,000, more preferably in the range of 50,000 to 350,000, further preferably in the range of 100,000 to 300,000, still more preferably in the range of 150,000 to 250,000. If the molecular weight is excessively large, flowability of cellulose acetate resin composition becomes low. As a result, it may be difficult to not only process it but also uniformly mix it in some cases. Conversely, if the molecular weight is excessively small, physical properties such as impact resistance of the cellulose acetate resin composition may deteriorate in some cases. The weight average molecular weight can be determined by gel permeation chromatography (GPC) (commercially available standard polystyrene can be used as a reference sample).

### <Component (B)>

The cellulose-based resin composition of the present embodiment comprises one or more phosphoric acid esters selected from the group consisting of triphenyl phosphate (also described as “TPP”), triethyl phosphate, tributyl phosphate, tricresyl phosphate, cresyl di-2,6-xylenyl phosphate, and a compound represented by the following formula (I):

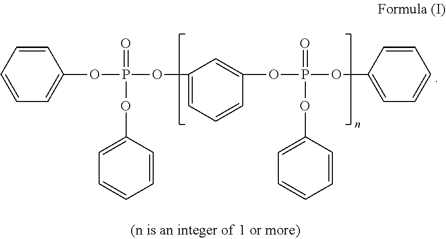

Component (B) functions as a flame retardant and a plasticizer, and can impart flame retardancy and processing stability to the resin composition. Moreover, the use of these predetermined phosphoric acid ester(s) can form the resin composition with high impact strength. Component (B) may be used alone, or may be used in combination of two or more types.

In the compound represented by the above formula (I), n in formula (I) is an integer of 1 or more, preferably 1 or more and 3 or less, and particularly preferably n=1.

In one aspect of the present embodiment, it is preferable that one or more phosphoric acid esters selected from the group consisting of triphenyl phosphate, triethyl phosphate, tributyl phosphate and tricresyl phosphate are used from the viewpoint of high compatibility with cellulose acetate.

In one aspect of the present embodiment, component (B) preferably comprises triphenyl phosphate (TPP). In one embodiment, a content of TPP in the total amount of component (B) is preferably 80% by mass or more, more preferably 90% by mass or more, and may be 100% by mass. TPP has low volatility and high compatibility with component (A). Moreover, the use of TPP can form a resin composition with high mechanical strength.

Examples of commercially available products that may be used as component (B) include ADEKA STAB PFR (product name) manufactured by ADEKA Co., Ltd., TPP (product name) and PX-110 (product name) manufactured by Daihachi Chemical Industry Co., Ltd.

In addition, in one aspect of the present embodiment, from the viewpoint of obtaining a molded body with high mechanical strength, it is preferred that the content of a phosphoric acid ester having low compatibility with component (A) (referred to as “phosphoric acid ester (b′)”) is small. Examples of the phosphoric acid ester (b′) include: a compound represented by the following formula:

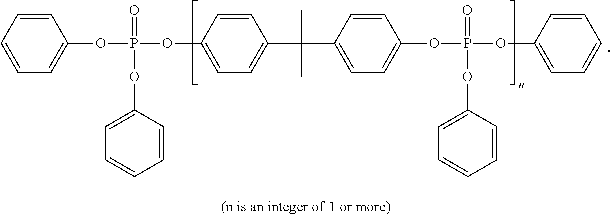

a compound represented by the following formula:

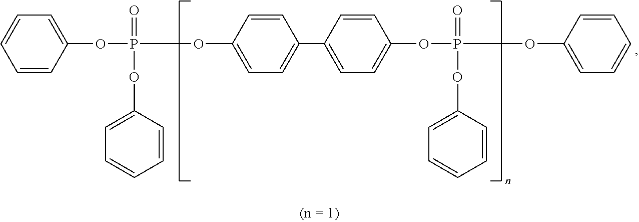

and a condensed phosphoric acid ester-based flame retardant represented by [(CH₃)₂C₆H₃O]₂P(O)OC₆H₄OP(O)[OC₆H₃ (CH₃)₂]₂. The content of the phosphoric acid ester (b′) in the resin composition is preferably 3% by mass or less, more preferably 1% by mass or less, and further more preferably 0% by mass.

In the cellulose-based resin composition, the content of component (A) based on 100% by mass of the total content of components (A) and (B) is preferably more than 70% by mass, more preferably 72.5% by mass or more, further preferably 74% by mass or more, and preferably 80% by mass or less, more preferably 77.5% by mass or less.

In one aspect of the present embodiment, the content of component (B) based on 100% by mass of the total content of component (A) and component (B) is preferably 20% by mass or more, more preferably 22.5% by mass or more, and preferably less than 30% by mass, more preferably 27.5% by mass or less, further preferably 26% by mass or less. When the content of component (B) is within the range, the resin composition can be excellent in processing stability and flame retardancy. In one aspect of the present embodiment, from the viewpoint of suppressing oozing (bleed-out), the content of component (B) based on 100% by mass of the total content of component (A) and component (B) is 26% by mass or less, more preferably 25% by mass or less, and further preferably 22.5% by mass or less. If the content of component (B) is too high, bleed-out may occur under a high temperature and high humidity environment in some cases. On the other hand, if the content of component (B) is too low, processing stability and flame retardancy may become insufficient in some cases.

The total content of component (A) and component (B) based on 100% by mass of the total amount of the cellulose-based resin composition is, but is not limited to, preferably 60% by mass or more, more preferably 70% by mass or more, and preferably less than 90% by mass, more preferably 89.8% by mass or less, further preferably 89.5% by mass or less.

### <Component (C)>

The cellulose-based resin composition of the present embodiment comprises an anti-dripping agent as component (C). The inclusion of component (C) allows the cellulose-based resin composition to shrink when heated, which results in preventing the molten resin from dropping (dripping) and spreading combustion. The anti-dripping agent is preferably a fluorine-based anti-dripping agent (fluorine-containing polymer), and more preferably contains a fluorine-containing polymer to form a fibrous structure (fibrillar structure) in the resin composition. Blending the fluorine-containing polymer can enhance the suppressing effect of the drip phenomenon during combustion.

Examples of the anti-dripping agent include fluorine-based resins such as polytetrafluoroethylene (PTFE), tetrafluoroethylene-based copolymers (e.g., tetrafluoroethylene/hexafluoropropylene copolymers, etc.), acrylic-modified resins of polytetrafluoroethylene, polyvinylidene fluoride and polyhexafluoropropylene, a compound of an alkali metal salt of perfluoroalkanesulfonic acid and an alkaline-earth metal salt of perfluoroalkanesulfonic acid such as sodium perfluoromethanesulfonate, potassium perfluoro-n-butanesulfonate, potassium perfluoro-t-butanesulfonate, sodium perfluorooctanesulfonate, and calcium perfluoro-2-ethylhexanesulfonate. Further, as the fluorine-containing polymer, there can also be used fluoropolymers of various forms such as fine powdery fluoropolymers, aqueous dispersions of fluoropolymers, a mixture of powdery fluoropolymer and acrylonitrile-styrene copolymer, and a mixture of powdery fluoropolymer and polymethyl methacrylate. Similarly, a silicone compound such as silicone rubbers and a layered silicate such as talc may be blended as another anti-dripping agent. These may be used alone or in combination of two or more.

Among these, a fluorine-based anti-dripping agent having fibril-forming ability is preferred, and polytetrafluoroethylene (PTFE) is particularly preferred. The molecular weight of the fluorine-based anti-dripping agent (particularly PTFE) is preferably 1,000,000 to 10,000,000, more preferably 2,000,000 to 9,000,000, in terms of number-average molecular weight determined from standard specific gravity. Such PTFE may be in solid form or in the form of an aqueous dispersion. In one embodiment, a content of PTFE in the total amount of component (C) is preferably 80% by mass or more, more preferably 90% by mass or more, and may be 100% by mass.

In the cellulose-based resin composition, the content of component (C) based on 100% by mass of the total content of component (A), component (B), component (C), and component (D) is preferably 0.01% by mass or more, more preferably 0.1% by mass or more, more preferably 0.2% by mass or more, further preferably 0.3% by mass or more, still further preferably 0.5% by mass or more, and is preferably 2% by mass or less, more preferably 1.5% by mass or less, further preferably 1.0% by mass or less. If the content of component (C) is too high, processing stability may decrease in some cases. On the other hand, if the content of component (C) is too low, flame retardancy may become insufficient in some cases.

### <Component (D)>

The cellulose-based resin composition of the present embodiment comprises a metal hydroxide as component (D). The inclusion of the metal hydroxide can improve flame retardancy of the resin composition.

Examples of the metal hydroxide include aluminum hydroxide, magnesium hydroxide, calcium hydroxide, and the like. Among these, aluminum hydroxide is particularly preferred because it has a high endothermic effect and excellent flame retardancy. The surface of the metal hydroxide may be surface-treated with various organic substances such as epoxy resin and phenol resin. One type of the metal hydroxide may be used alone, or two or more types thereof may be used in combination. In one aspect, the content of aluminum hydroxide in the total amount of component (D) is preferably 80% by mass or more, more preferably 90% by mass or more, and may be 100% by mass.

The 50% particle diameter (median diameter, D₅₀) of the metal hydroxide is not particularly limited, but it is preferably 0.5 μm or more and 20 μm or less, more preferably 1 μm or more and 10 μm or less, and further preferably 2 μm or more and 4 μm or less. The metal hydroxide having 50% particle size within the range is excellent in dispersibility in the resin composition, leading to improved flame retardancy and mechanical properties. If the 50% particle size of the metal hydroxide is too small, the viscosity of the resin composition may increase and moldability may deteriorate in some cases. The increase in viscosity may also increase shear forces during kneading and molding, resulting in degradation of other components in some cases. On the other hand, if the 50% particle size of the metal hydroxide is too large, unevenness on the surface of the resin composition may be generated and the design property may deteriorate in some cases. Here, the average particle diameter of the metal hydroxide can be determined, for example, by measuring a volume-basis median diameter by a diffraction scattering method.

The content of component (D) (metal hydroxide) in the resin composition is preferably 10% by mass or more, more preferably 12.5% by mass or more, further preferably 15% by mass or more, and preferably 20% by mass or less, more preferably 17.5% by mass or less, based on 100% by mass of the total contents of component (A), component (B), component (C), and component (D) (also described as “components (A) to (D)”). If the content of component (D) is too low, flame retardancy may become insufficient in some cases. On the other hand, if the content of component (D) is too high, toughness may decrease, resulting in the resin composition with inferior mechanical properties in some cases.

In one aspect of the present embodiment, in the cellulose-based resin composition, from the viewpoint of being excellent in both of flame retardancy and mechanical strength and being capable of suppressing bleed-out of component (B), it is preferable that the content of component (B) based on 100% by mass of the total content of components (A) and (B) is 20% by mass or more and less than 30% by mass, and the content of component (D) based on 100% by mass of the total content of components (A) to (D) is 10% by mass or more and 20% by mass or less.

In one aspect of the present embodiment, from the viewpoint of obtaining the resin composition with particularly excellent flame retardancy, it is preferable that the content of component (B) based on 100% by mass of the total content of component (A) and component (B) is 22.5 to 26% by mass, and the content of component (D) based on 100% by mass of the total content of components (A) to (D) is 12.5 to 17.5% by mass.

As one example of the present embodiment, for example, when the content of component (B) based on 100% by mass of the total content of component (A) and component (B) is 25% by mass, and the content of component (D) based on 100% by mass of the total content of components (A) to (D) is 17.5% by mass, the resin composition particularly excellent in flame retardancy can be obtained. (See, Example 9 as below.)

In one aspect of the present embodiment, from the viewpoint of obtaining the resin composition particularly with excellent toughness, it is preferable that the content of component (B) based on 100% by mass of the total content of component (A) and component (B) is preferably 20% by mass or more and less than 30% by mass, more preferably 22.5% by mass or more and less than 30% by mass, and the content of component (D) based on 100% by mass of the total content of components (A) to (D) is preferably 10% by mass or more and 17.5% by mass or less, more preferably 10% by mass or more and 12.5% by mass or less.

From the viewpoint of obtaining the resin composition with excellent toughness, in one aspect of the present embodiment, it is preferable that the content of component (B) based on 100% by mass of the total content of component (A) and component (B) is 22.5% by mass or more and less than 30% by mass, and the content of component (D) based on 100% by mass of the total content of components (A) to (D) is 10% by mass or more and 17.5% by mass or less.

From the viewpoint of obtaining the resin composition with excellent toughness, in one aspect of the present embodiment, it is preferable that the content of component (B) based on 100% by mass of the total content of component (A) and component (B) is 20% by mass or more and less than 30% by mass, and the content of component (D) based on 100% by mass of the total content of components (A) to (D) is 10% by mass or more and 12.5% by mass or less.

In one aspect of the present embodiment, from the viewpoint of obtaining the resin composition particularly with excellent toughness, it is preferable that the content of component (B) based on 100% by mass of the total content of component (A) and component (B) is 22.5% by mass or more and less than 30% by mass, and the content of component (D) based on the total content of components (A) to (D) is 10 to 12.5% by mass.

The cellulose-based resin composition according to the present embodiment may comprise other components without impairing the desired properties when formed into a molded body. In one aspect, for example, the total amount of component (A), component (B), component (C) and component (D) based on the total of the cellulose-based resin composition is set in the range of preferably 75 to 100% by mass, more preferably 80% by mass or more, more preferably 90% by mass or more, further preferably 95% by mass or more, still more preferably 98% by mass or more.

The resin composition may contain, as other components, an additive usually used in general resin materials for molding, as long as the purpose of the present embodiment is not impaired. Examples of the additive include a colorant, an antioxidant such as a phenol-based compound and a phosphorous compound, a light stabilizer, an ultraviolet absorber, an antistatic agent, an antibacterial/antifungal agent, a filler, and the like. In particular, an additive usually used in common cellulose resins may be contained.

### (Colorant)

In one aspect, the cellulose-based resin composition may comprise a colorant such as a black colorant. Examples of the black colorant include carbon black.

The content of the colorant such as a black colorant is not limited, but may be set in the range of 0.01 to 10 phr based on the total mass of components other than the colorant (i.e. 0.01 to 10 parts by mass based on 100 parts by mass of the total mass of components other than the colorant in the cellulose-based resin composition, and the basis for the content of the colorant is the same below.). In one aspect, from the viewpoint of obtaining a sufficient coloring effect, the content of the colorant is preferably 0.05 phr or more, and preferably 0.1 phr or more based on the total mass of components other than the colorant. From the viewpoint of suppressing the excess amount of colorant while obtaining sufficient coloring effect, the content is preferably 5 phr or less, more preferably 3 phr or less, and further preferably 2 phr or less.

From the viewpoint of appearance such as glossiness, the content of the colorant is preferably 1 phr or less, more preferably 0.3 phr or less, further preferably 0.2 phr or less, and still more preferably 0.1 phr or less.

To the resin composition according to the present embodiment, an inorganic or organic granular or fibrous filler may be added, if necessary. Addition of filler makes it possible to improve strength and rigidity. Examples of the filler include mineral particles (talc, mica, baked siliceous earth, kaolin, sericite, bentonite, smectite, clay, silica, quartz powder, glass beads, glass powder, glass flake, milled fiber, wollastonite, etc.), boron-containing compounds (boron nitride, boron carbide, titanium boride, etc.), metal carbonates (magnesium carbonate, heavy calcium carbonate, light calcium carbonate, etc.), metal silicates (calcium silicate, aluminum silicate, magnesium silicate, magnesium aluminosilicate, etc.), metal oxides (magnesium oxide, etc.), metal sulfates (calcium sulfate, barium sulfate, etc.), metal carbides (silicon carbide, aluminum carbide, titanium carbide, etc.), metal nitrides (aluminum nitride, silicon nitride, titanium nitride, etc.), white carbon and various metal foils. Examples of the fibrous filler include organic fibers (natural fiber, papers, etc.), inorganic fibers (glass fiber, asbestos fiber, carbon fiber, silica fiber, silica alumina fiber, wollastonite, zirconia fiber, potassium titanate fiber, etc.) and metal fibers. These fillers may be used singly or in combination of two or more types.

In one aspect of the present embodiment, the resin composition may comprise a glass fiber. The inclusion of the glass fiber in the resin composition improves the strength of the molded body. Although the glass fiber is not particularly limited, the fiber length of the glass fiber in the shape before melt-kneading is preferably 0.5 mm or more, and preferably 30 mm or less, more preferably 10 mm or less. The cross-sectional shape of the glass fiber is not particularly limited, and examples thereof include circular, elliptical, long-oval, and non-circular shapes. The fiber diameter of the glass fiber when the cross-sectional area is converted to a perfect circle may be, for example, 3 to 20 μm. In one aspect of the present embodiment, the content of the glass fiber based on the total mass of the resin composition may be 0% by mass, but is preferably 0.5% by mass or more, more preferably 1% by mass or more, further preferably 3% by mass or more, and preferably 20% by mass or less, more preferably 10% by mass or less, further preferably 8% by mass or less.

In one aspect, the resin composition of the present embodiment preferably has a low content of a polylactic acid resin and an aromatic polycarbonate resin. If the polylactic acid resin or the aromatic polycarbonate resin is contained, white clouding occurs due to low compatibility with cellulose acetate, which makes it difficult to obtain sufficient flame retardancy and mechanical properties. The content of these components is preferably 3% by mass or less, more preferably 1% by mass or less, and further preferably 0% by mass, based on the total mass of the resin composition.

### <Method for Producing Cellulose-based Resin Composition>

A method for producing the cellulose-based resin composition is not particularly limited, and for example, the cellulose-based resin composition may be obtained by melting and mixing component (A), component (B), component (C), component (D) and, if necessary, other components in a usual mixer. As the mixer, for example, a compounding apparatus such as a tumbler mixer, a ribbon blender, a single-screw or multi-screw mixing extruder, a kneader, or a kneading roll may be used. After the melt-mixing, if necessary, granulation into an appropriate shape may be carried out; for example, pellets may be formed by a pelletizer.

### <Molded Body>

The molded body formed using the cellulose-based resin composition according to the present embodiment may be formed into a desired shape by a usual molding method, and the shape is not limited and the thickness of the molded body is not limited. From the viewpoint of the strength of the molded body, the thickness is preferably 0.5 mm or more, more preferably 0.8 mm or more. Furthermore, from the viewpoint of flame retardancy, the thickness is preferably 1.0 mm or more, more preferably 1.6 mm or more, more preferably 2.0 mm or more, and further preferably 3.2 mm or more. On the other hand, the upper limit of the thickness of the molded body is not particularly limited and may be appropriately set depending on the required shape, strength, etc., and for example, even if the thickness is set to 10 mm or less, or even 5 mm or less, sufficient physical properties can be achieved.

The cellulose-based resin composition according to the present embodiment can be formed into a molded body in accordance with an intended use by a common molding method such as injection molding, injection compression molding, extrusion molding, and hot press molding, or the like.

Since the molded body formed of the cellulose-based resin composition according to the present embodiment is excellent in flame retardancy and mechanical characteristics, the molded body may be applied to a housing, an exterior package, a decorative plate, and a decorative sheet, and may be used in place of, for example, members used in electronic devices, home appliances, building materials, furniture, and automobiles. The molded body may be used in, for example, housing and exterior parts of electronic devices or home appliances, interior members of building materials, and interior materials of automobiles.

According to the present embodiment, it is possible to provide products including a molded body formed using the resin composition of the present invention, such as electronic devices or home appliances, automobiles, building materials, furniture, or the like.

Examples of use for electronic devices or home appliances include housings for personal computers, fixed phones, mobile phone terminals, smart phones, tablets, POS terminals, routers, projectors, speakers, lighting fixtures, copiers, multifunction devices, calculators, remote controllers, refrigerators, washing machines, humidifiers, dehumidifiers, video recorders/players, vacuum cleaners, air conditioners, rice cookers, electric shavers, electric toothbrushes, dishwashers, and broadcast equipment; dial plates and outer packages for timepieces; and cases for mobile terminals such as smart phones.

Examples of use for automobiles include interior parts such as instrument panels, dashboards, cup holders, door trims, armrests, door handles, door locks, handles, brake levers, ventilators and shift levers.

### EXAMPLES

Hereinafter, an embodiment of the present invention will be explained in details by using examples, but the present invention is not limited to these examples.

Each component used in the production of the resin compositions of Examples and Comparative Examples is shown below.

### <Component (A)>

(al) Cellulose acetate (CA) (manufactured by Daicel, product name: L-50, acetyl group introduction ratio (degree of substitution) DS=2.4, degree of acetylation: 55%, degree of polymerization based on 6% viscosity: 180)

### <Component (B)>

(b1) Triphenyl phosphate (TPP) (manufactured by Daihachi Chemical Industry, product name: TPP)
   <Phosphoric Acid Ester (b′)>
(b1′) The compound represented by the following formula:

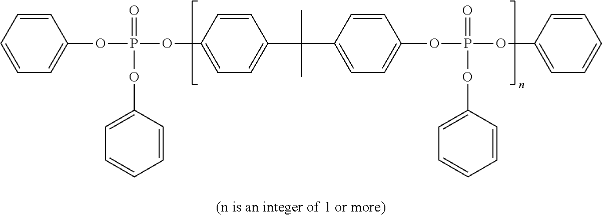

(manufactured by ADEKA Co., Ltd., product name: ADEKA STAB FP-600)
(b2′) The compound represented by the following formula:

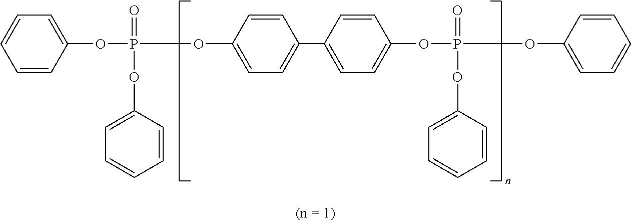

(manufactured by ADEKA Co., Ltd., product name: ADEKA STAB FP-900L)
(b3′)[(CH₃)₂C₆H₃O]₂P(O)OC₆H₄OP(O)[OC₆H₃ (CH₃)₂]₂ (Daihachi Chemical Co., Ltd., Product name: PX-200)

### <Component (C)>

(c1) Polytetrafluoroethylene (PTFE) (manufactured by Daikin Industries, Ltd., product name: Polyflon MPA FA-500H)

### <Component (D)>

(d1) Aluminum hydroxide (manufactured by Nippon Light Metal Co., Ltd., product name: BE023) (average particle diameter: 2 μm)
(d2) Aluminum hydroxide (manufactured by Nippon Light Metal Co., Ltd., product name: BE043-STE) (average particle diameter: 4 μm, surface is treated with epoxy silane coupling agent.)

### <Compatibility>

In order to confirm the compatibility of component (al) and each phosphoric acid ester, they were mixed so that the mass ratio satisfies that component (al): phosphoric acid ester=80:20 and kneaded in the same manner as described below, and then the appearances thereof were observed.

When component (b1) was used as the phosphoric acid ester, it was found that it was transparent without generating white clouding and compatibility was high.

When components (b1′), (b2′), and (b3′) were respectively used as the phosphoric acid esters, they lacked thermoplasticity and thus could not be discharged from the kneading machine and could not be kneaded.

### Examples 1 to 10, Comparative Examples 1 to 5

The materials shown in Tables 2 to 4 were prepared as constituent materials of the target cellulose-based resin composition. Next, the constituent materials were thoroughly mixed by hand mixing at the blending ratios shown in Tables 2 to 4. Note that the resin materials were dried in advance at 80° C. for 5 hours. In Tables 2 to 4, the unit of numerical values regarding the blending ratio is mass %. The contents of component (al) and component (b1) are each the proportions (mass %) based on 100 mass % of the total of component (al) and component (b1). The contents of components (c1), (d1) and (d2) are each the proportions (mass %) of each component based on 100% by mass of the total of component (al), component (b1), component (c1), component (d1), and component (d2).

### (Kneading Method)

The obtained mixture was put into a co-rotating twin-screw extruder (manufactured by STEER, product name: Omega30H [φ30, L/D-60]), kneaded at a kneading temperature of 200° C. and a rotation speed of 120 rpm, and then recovered by water cooling to form a pellet. The resulting pellets were dried at 80° C. for 5 hours.

### (Preparation of Sample for Charpy Impact Value Measurement: Evaluation Sample 1)

The obtained pellets were dried again at 80° C. for 5 hours immediately before molding and used in an injection molding machine (manufactured by Toshiba Machine, product name: EC20P) to produce a molded body (evaluation sample 1) having the following shape.
Molded body: JIS K 7162 test piece 1A shape
The molding conditions were set as follows.
Cylinder temperature of the molding machine: 190-230° C.
Mold temperature: 60-70° C.
Holding pressure: 60-100 MPa

### (Preparation of Sample for Combustion Test: Evaluation Sample 2)

The obtained pellets were dried again at 80° C. for 5 hours immediately before molding and used in an injection molding machine (manufactured by Toshiba Machine, product name: EC20P) to produce a molded body (evaluation sample 2) having the following shape.
Molded body: length 125 mm, width 13 mm, thickness 1.6 mm, 2.0 mm, 3.2 mm
The molding conditions were set as follows.
Cylinder temperature of the molding machine: 190-230° C.
Mold temperature: 60-70° C.
Holding pressure: 60-100 MPa

### <Combustion Test (UL94V Test)>

In the combustion test, the test piece for combustion test (evaluation sample 2) obtained by injection molding was left in a constant temperature room at a temperature of 23° C. and a humidity of 50% for 48 hours, and then the test was conducted in accordance with the UL94 test (combustion test for plastic materials for parts in appliances) released by Underwriters Laboratories. UL94V refers to a method of evaluating flame retardancy based on the combustion time, the dripping property and the like after flame (20±1 mm flame) of a burner is contacted for 10 seconds to the bottom edge of the test piece which is held vertically and has a predetermined size, and the evaluation is classified into classes indicated in the following Table 1.

TABLE 1

| Judgment item | V-0 | V-1 | V-2 |
|---|---|---|---|
| Each flaming combustion time after | ≤10 sec | ≤30 sec | ≤30 sec |
| first-time (t1) and second-time | | | |
| (t2) contact with flame | | | |
| Total flaming combustion time of 5 | ≤50 sec | ≤250 sec | ≤250 sec |
| samples (t1 + t2 of 5 samples) | | | |
| Total of flaming combustion time (t2) | ≤30 sec | ≤60 sec | ≤60 sec |
| and flameless combustion time (t3) | | | |
| after second-time flame contact | | | |
| Combustion reached to the holding | absent | absent | absent |
| clamp of each sample (flaming | | | |
| or flameless combustion) | | | |
| Ignition of marking cotton | absent | absent | present |
| by flaming substances or drips | | | |

The order of flame retardancy from best to worst is V-0, V-1, and V-2. Here, those that did not fall under any of the ranks from V-0 to V-2 (i.e. those that were low in flame retardancy) were classified as V-non-conforming.

The above flaming combustion time is a time length in which flaming combustion of the test piece continues after the ignition source (burner) is removed, and t1 is the combustion time after the first-time flame contact; t2 is the combustion time after the second-time flame contact; and t3 is an afterglow (non-flaming combustion) time after the second-time flame contact. The second-time flame contact is carried out by applying a flame of the burner to the test piece immediately after the flame goes out after the first-time flame contact, for 10 seconds. Furthermore, the ignition of the cotton by the dripping is determined by whether the marking cotton placed about 300±10 mm below the lower end of the test piece is ignited by drops (drips) from the test piece.

### <Charpy Impact Test>

A Charpy impact test was carried out using evaluation sample 1 in accordance with JISK7111-1 (with notch: type A (notch cutter tip R 0.25 mm)).

### <Bleed-Out Test>

Evaluation sample 1 was placed in a thermo-hygrostat chamber at 60° C. and 85% RH, and the presence or absence of bleed-out after 24 hours was visually evaluated. The case in which bleed-out was not observed was evaluated as “o”, and the case in which bleed out was observed was evaluated as “x”.

The results are shown in Tables 2 to 4.

TABLE 2

| | | Com.-Ex. | Com.-Ex. | Ex. | Com.-Ex. | Com.-Ex. |
|---|---|---|---|---|---|---|
| | Unit, etc. | 1 | 2 | 1 | 3 | 4 |
| (a1) | mass % | 80.0 | 80.0 | 80.0 | 80.0 | 80.0 |
| (b1) | mass % | 20.0 | 20.0 | 20.0 | 20.0 | 20.0 |
| (c1) | mass % | 0 | 0.5 | 0.5 | 0.5 | 0 |
| (d1) | mass % | 0 | 0 | 0 | 0 | 10.0 |
| (d2) | mass % | 0 | 0 | 20.0 | 30.0 | 0 |
| Flame | Plate | | | V-0 | V-0 | V-2 |
| retardance | thickness | | | | | |
| (UL94) | 1.6 mm | | | | | |
| | Plate | V-Non- | V-Non- | V-0 | V-0 | |
| | thickness | conforming | conforming | | | |
| | 2.0 mm | | | | | |
| | Plate | V-Non- | V-Non- | | | |
| | thickness | conforming | conforming | | | |
| | 3.2 mm | | | | | |
| Charpy | kJ/m² | 9 | 9 | 4 | 2 | 3 |
| Impact test | | | | | | |
| Bleed-out test | ∘ | ∘ | ∘ | ∘ | ∘ | ∘ |

Com.-Ex.: Comparative Example
Ex.: Example

TABLE 3

| | | Ex. | Ex. | Ex. | Ex. | Com.-Ex. |
|---|---|---|---|---|---|---|
| | Unit, etc. | 2 | 3 | 4 | 5 | 5 |
| (a1) | mass % | 80.0 | 80.0 | 80.0 | 75.0 | 70.0 |
| (b1) | mass % | 20.0 | 20.0 | 20.0 | 25.0 | 30.0 |
| (c1) | mass % | 0.5 | 1.0 | 0.5 | 0.5 | 0.5 |
| (d1) | mass % | 10.0 | 10.0 | 15.0 | 10.0 | 10.0 |
| (d2) | mass % | 0 | 0 | 0 | 0 | 0 |
| Flame | Plate | V-Non- | V-Non- | V-Non- | V-Non- | V-Non- |
| retardance | thickness | conforming | conforming | conforming | conforming | conforming |
| (UL94) | 1.6 mm | | | | | |
| | Plate | V-Non- | V-Non- | V-Non- | V-Non- | V-1 |
| | thickness | conforming | conforming | conforming | conforming | |
| | 2.0 mm | | | | | |
| | Plate | V-1 | V-1 | V-1 | V-1 | V-1 |
| | thickness | | | | | |
| | 3.2 mm | | | | | |
| Charpy | kJ/m² | 7 | 8 | 4 | 6 | 12 |
| Impact test | | | | | | |
| Bleed-out test | Evaluation | ∘ | ∘ | ∘ | ∘ | x |

Ex.: Example
Com.-Ex.: Comparative Example

TABLE 4

| | Unit, etc. | Ex. 6 | Ex. 7 | Ex. 8 | Ex. 9 | Ex. 10 |
|---|---|---|---|---|---|---|
| (a1) | mass % | 80.0 | 74.0 | 75.0 | 75.0 | 77.5 |
| (b1) | mass % | 20.0 | 26.0 | 25.0 | 25.0 | 22.5 |
| (c1) | mass % | 0.5 | 0.5 | 0.5 | 0.5 | 0.5 |
| (d1) | mass % | 0 | 15.0 | 12.5 | 17.5 | 15.0 |
| (d2) | mass % | 10.0 | 0 | 0 | 0 | 0 |
| Flame | Plate | V-Non- | | | | |
| retardance | thickness | conforming | | | | |
| (UL94) | 1.6 mm | | | | | |
| | Plate | V-Non- | V-Non- | V-Non- | V-0 | V-Non- |
| | thickness | conforming | conforming | conforming | | conforming |
| | 2.0 mm | | | | | |
| | Plate | V-1 | V-0 | V-0 | V-0 | V-0 |
| | thickness | | | | | |
| | 3.2 mm | | | | | |
| Charpy | kJ/m² | 6 | 5 | 7 | 5 | 5 |
| Impact test | | | | | | |
| Bleed-out test | Evaluation | ∘ | ∘ | ∘ | ∘ | ∘ |

Ex.: Example

While the invention has been described with reference to example embodiments and examples thereof, the invention is not limited to these embodiments and examples. Various changes that can be understood by those of ordinary skill in the art may be made to forms and details of the present invention without departing from the spirit and scope of the present invention.

The whole or part of the example embodiments disclosed above may be described as, but not limited to, the following supplementary notes.

### Supplementary Note 1

A cellulose-based resin composition comprising:
component (A): cellulose acetate,
component (B): one or more phosphoric acid esters selected from the group consisting of triphenyl phosphate, triethyl phosphate, tributyl phosphate, tricresyl phosphate, cresyl di-2,6-xylenyl phosphate, and a compound represented by the following formula (I):

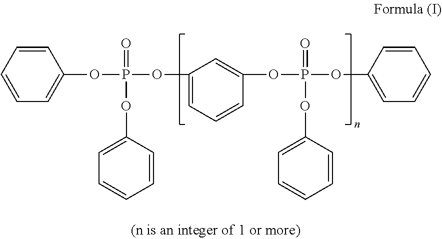

component (C): an anti-dripping agent, and
component (D): a metal hydroxide,
wherein a content of the component (B) is 20% by mass or more and less than 30% by mass based on 100% by mass of a total content of the component (A) and the component (B), and
a content of the component (D) is 10% by mass or more and 20% by mass or less based on 100% by mass of a total content of the components (A) to (D).

### Supplementary Note 2

The cellulose-based resin composition according to Supplementary note 1, wherein the component (B) comprises triphenyl phosphate.

### Supplementary Note 3

The cellulose-based resin composition according to Supplementary note 1 or 2, wherein the component (D) comprises aluminum hydroxide.

### Supplementary Note 4

The cellulose-based resin composition according to any one of Supplementary notes 1 to 3, wherein the component (C) comprises a fluorine-based anti-dripping agent.

### Supplementary Note 5

The cellulose-based resin composition according to any one of Supplementary notes 1 to 4, wherein the component (C) comprises polytetrafluoroethylene.

### Supplementary Note 6

The cellulose-based resin composition according to any one of Supplementary notes 1 to 5, wherein a content of the component (C) is 0.01% by mass or more, preferably 0.2% by mass or more, and 2% by mass or less, based on 100% by mass of a total content of the components (A) to (D).

### Supplementary Note 7

The cellulose-based resin composition according to any one of Supplementary notes 1 to 6, wherein a content of the component (D) is 12.5% by mass or more and 17.5% by mass or less based on 100% by mass of the total content of the components (A) to (D).

### Supplementary Note 8

The cellulose-based resin composition according to any one of Supplementary notes 1 to 7, wherein a content of the component (B) is 22.5% by mass or more and 26% by mass or less based on 100% by mass of the total content of the components (A) and (B).

### Supplementary Note 9

A molded body formed using the cellulose-based resin composition according to any one of Supplementary notes 1 to 8.

This application is based upon and claims the benefit of priority from Japanese patent application No. 2021-124850, filed on Jul. 29, 2021, the disclosures of which are incorporated herein in their entirety by reference.

While the invention has been described with reference to example embodiments and examples thereof, the invention is not limited to these embodiments and examples. Various changes that can be understood by those of ordinary skill in the art may be made to forms and details of the present invention without departing from the spirit and scope of the present invention.

What is claimed is:

1. A cellulose-based resin composition comprising:
component (A): cellulose acetate,
component (B): one or more phosphoric acid esters selected from the group consisting of triphenyl phosphate, triethyl phosphate, tributyl phosphate, tricresyl phosphate, cresyl di-2,6-xylenyl phosphate, and a compound represented by the following formula (I): 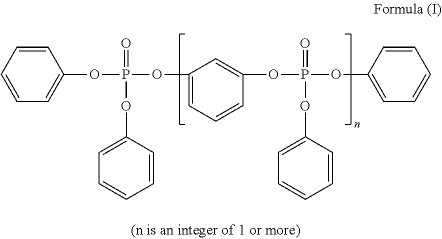
component (C): an anti-dripping agent, and
component (D): a metal hydroxide,
wherein a content of the component (B) is 20% by mass or more and less than 30% by mass based on 100% by mass of a total content of the component (A) and the component (B), and
a content of the component (D) is 10% by mass or more and 20% by mass or less based on 100% by mass of a total content of the components (A) to (D).

2. The cellulose-based resin composition according to claim 1, wherein the component (B) comprises triphenyl phosphate.

3. The cellulose-based resin composition according to claim 1, wherein the component (D) comprises aluminum hydroxide.

4. The cellulose-based resin composition according to claim 1, wherein the component (C) comprises a fluorine-based anti-dripping agent.

5. The cellulose-based resin composition according to claim 1, wherein the component (C) comprises polytetrafluoroethylene.

6. The cellulose-based resin composition according to claim 1, wherein a content of the component (C) is 0.01% by mass or more and 2% by mass or less based on 100% by mass of a total content of the components (A) to (D).

7. The cellulose-based resin composition according to claim 1, wherein a content of the component (D) is 12.5% by mass or more and 17.5% by mass or less based on 100% by mass of the total content of the components (A) to (D).

8. The cellulose-based resin composition according to claim 1, wherein a content of the component (B) is 22.5% by mass or more and 26% by mass or less based on 100% by mass of the total content of the components (A) and (B).

9. A molded body formed using the cellulose-based resin composition according to claim 1.
